(19) United States
(12) Patent Application Publication
(10) Pub. No.: US 2014/0156087 A1
(43) Pub. Date: Jun. 5, 2014

(54) HVAC CONTROLLER THAT FACILITATES INSTALLER SETUP VIA A REMOTE USER INTERFACE

(71) Applicant: HONEYWELL INTERNATIONAL INC., Morristown, NJ (US)

(72) Inventor: John Amundson, Minneapolis, MN (US)

(73) Assignee: HONEYWELL INTERNATIONAL INC., Morristown, NJ (US)

(21) Appl. No.: 13/691,430

(22) Filed: Nov. 30, 2012

(51) Int. Cl. G05B 13/02

(52) U.S. Cl. CPC G05B 13/02
USPC 700/278

(57) ABSTRACT

A thermostat may transmit a configuration parameter package in a computer readable form over a network to a remote device. The configuration parameter data package may include a listing of available configuration parameters for the wireless thermostat, as well as information regarding available parameter values for each of the configuration parameter. The thermostat may subsequently receive selection of one or more available parameter values from the remote device, and in some cases, may in response transmit a second configuration parameter package that is dependent, at least in part, on the received selected parameter value(s).

### TECHNICAL FIELD

The present disclosure relates generally to HVAC systems, and more particularly to HVAC controllers that accommodate and/or facilitate control of an HVAC system from a remote location.

### BACKGROUND

Heating, ventilation, and/or air conditioning (HVAC) systems are often used to control the comfort level within a building or other structure. Such HVAC systems typically include an HVAC controller that controls various HVAC components of the HVAC system in order to affect and/or control one or more environmental conditions within the building. In some cases, it may be desirable for a user to be able to setup and/or affect the operation of an HVAC system from a location remote from the HVAC controller.

### SUMMARY

The present disclosure relates generally to HVAC systems, and more particularly to HVAC controllers that accommodate and/or facilitate control of an HVAC system from a location remote from the HVAC controller. In one illustrative embodiment, a building controller for controlling one or more HVAC components of an HVAC system may include an input/output port and a controller in communication with the input/output port. The controller may be configured to publish a first configuration parameter data package in a computer readable form, wherein the first configuration parameter data package may include a first configuration parameter identifier for a first configuration parameter of the controller and information regarding available parameter values for the first configuration parameter. The controller may be configured to transmit the published first configuration parameter data package via the input/output port of the building controller. In some instances, the first configuration parameter data package may be published to a web service that is accessible from a location remote from the building controller.

After the controller transmits the published first configuration parameter data package via the input/output port of the building controller, the controller may receive a selection of a first parameter value from the available parameter values for the first configuration parameter via the input/output port. In some instances, a user may select the first parameter value via the web service, sometimes using a user interface of a remote device such as a mobile phone, tablet computer, laptop computer, personal computer and/or any other device, as desired. The controller may then set the parameter value of the first configuration parameter to the selected first parameter value for use by a control algorithm that is executed during subsequent operation of the building controller. Additionally, after the controller receives the selection of the first parameter value from the available parameter values for the first configuration parameter via the input/output port, the controller may publish a second configuration parameter data package, wherein the second configuration parameter data package may include a second configuration parameter identifier for a second configuration parameter of the building controller and information regarding available parameter values for the second configuration parameter. The controller may transmit the published second configuration parameter data package via the input/output port of the building controller. In some cases, the information regarding available parameter values for the second configuration parameter may be dependent, at least in part, on the received first parameter value.

In another illustrative embodiment, a computer readable medium having stored thereon in a non-transitory state a program code for use by a remote device connectable to a wireless network may cause a remote device to execute a method for configuring a building controller including: receiving a configuration parameter data package over the wireless network, wherein the configuration parameter data package includes a listing of available configuration parameters for the building controller, as well as information regarding available parameter values for each of the configuration parameters; soliciting input from a user of the remote device to select a parameter value for at least two of the available configuration parameters; and transmitting the selected parameter values for the at least two of the available configuration parameters over the wireless network. The configuration parameter data package may further include one or more rules relating to interdependencies between two or more of the available configuration parameters and/or between the available parameter values for two or more of the available configuration parameters. Additionally, the wireless device may be any one of a mobile phone, tablet computer, laptop computer, personal computer and/or any other device configured for wireless communication over one or more wireless networks. In some instances, the program code may be stored on an external server for download to the remote device(s).

In yet another illustrative embodiment, a computer readable medium having stored thereon in a non-transitory state a program code for use by a remote wireless device connectable to a wireless network may cause the remote wireless device to execute a method for configuring a building controller including: receiving a first set of data relating to the first configuration parameter over the wireless network without first specifically requesting data for a first configuration parameter relating to a configuration setting for the building controller; soliciting input from a user of the remote wireless device to select a value for the first configuration parameter; transmitting the selected value for the first configuration parameter over the wireless network; without first specifically requesting data for a second configuration parameter relating to another configuration setting for the building controller, receiving a second set of data relating to the second configuration parameter over the wireless network, wherein the second set of data relating to the second configuration parameter is dependent upon the selected value for the first configuration parameter; soliciting input from the user to select a value for the second configuration parameter; and transmitting the selected value for the second configuration parameter over the wireless network.

The preceding summary is provided to facilitate an understanding of some of the features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following detailed description of various embodiments in connection with the accompanying drawings, in which:

FIG. 1 is a schematic view of an illustrative HVAC system servicing a building or structure;

FIG. 2 is a schematic view of an illustrative HVAC control system that may facilitate access and/or control of the HVAC system of FIG. 1;

FIG. 3 is a schematic block diagram of an illustrative HVAC controller;

FIG. 4 is a schematic block diagram of an illustrative remote device that may be used to communicate with and/or control the illustrative HVAC controller of FIG. 3; and

FIGS. 5A-10 show illustrative screens that may be displayed on the user interface of a remote device to setup and/or configure an HVAC controller.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements throughout the several views. The detailed description and drawings show several embodiments which are meant to illustrative of the claimed disclosure.

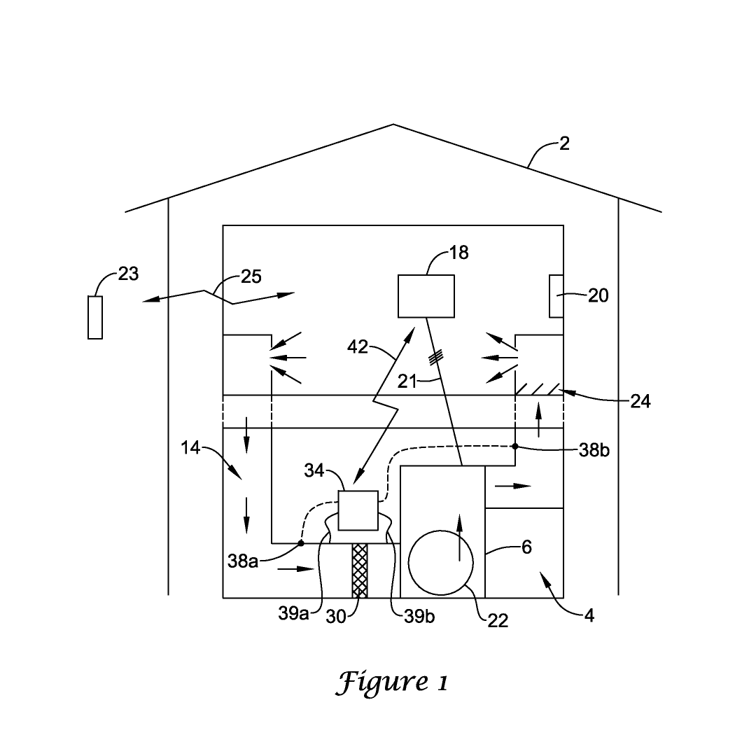

FIG. 1 is a schematic view of a building 2 having an illustrative heating, ventilation, and air conditioning (HVAC) system 4. While FIG. 1 shows a typical forced air type HVAC system, other types of HVAC systems are contemplated including, but not limited to, boiler systems, radiant heating systems, electric heating systems, cooling systems, heat pump systems, and/or any other suitable type of HVAC system, as desired. The illustrative HVAC system 4 of FIG. 1 includes one or more HVAC components 6, a system of ductwork and air vents including a supply air duct 10 and a return air duct 14, and one or more HVAC controllers 18. The one or more HVAC components 6 may include, but are not limited to, a furnace, a heat pump, an electric heat pump, a geothermal heat pump, an electric heating unit, an air conditioning unit, a humidifier, a dehumidifier, an air exchanger, an air cleaner, a damper, a valve, and/or the like.

It is contemplated that the HVAC controller(s) 18 may be configured to control the comfort level in the building or structure by activating and deactivating the HVAC component(s) 6 in a controlled manner. The HVAC controller(s) 18 may be configured to control the HVAC component(s) 6 via a wired or wireless communication link 21. In some cases, the HVAC controller(s) 18 may be a thermostat, such as, for example, a wall mountable thermostat, but this is not required in all embodiments. Such a thermostat may include (e.g. within the thermostat housing) or have access to a temperature sensor for sensing an ambient temperature at or near the thermostat. In some instances, the HVAC controller(s) 18 may be a zone controller, or may include multiple zone controllers each monitoring and/or controlling the comfort level within a particular zone in the building or other structure.

An illustrative HVAC controller, which is not meant to be limiting in any way, is disclosed in: US Published Patent Application No. 20090140062, entitled “HVAC CONTROLLER THAT SELECTIVELY REPLACES OPERATING INFORMATION ON A DISPLAY WITH SYSTEM STATUS INFORMATION”; US Published Application No. 20090143880, entitled “HVAC CONTROLLER WITH CONTEXT SENSITIVE HELP SCREENS”; US Published Application No. 20090143918, entitled “METHOD AND APPARATUS FOR CONFIGURING AN HVAC CONTROLLER”; US Published Application No. 20090143916, entitled “HVAC CONTROLLER HAVING A PARAMETER ADJUSTMENT ELEMENT WITH A QUALITATIVE INDICATOR”; US Published Application No. 20090143879, entitled “HVAC CONTROLLER WITH PARAMETER CLUSTERING”; US Published Application No. 20090140056, entitled “HVAC CONTROLLER WITH QUICK SELECT FEATURE,” the entireties of which are incorporated herein by reference for all purposes.

In some cases, the HVAC system 4 may include an internet gateway or other device 20 that may permit the HVAC controller 18, as described herein, to communicate over a wired or wireless network 25 with a remote device 23. A non-limiting example of a gateway device is Honeywell Inc.'s REDLINK™ internet gateway. In some cases, the network 25 may be a wireless local area network (WLAN) or a wide area network (WAN) such as, for example, the Internet. The remote device 23 may be used to communicate with and/or control the HVAC controller(s) 18 from a remote location outside of and away from the building 2. The remote device 23 may be any one of a mobile phone including a smart phone, a PDA, a tablet computer, a laptop or personal computer, an e-Reader, and/or the like. These are just some examples.

In the illustrative HVAC system 4 shown in FIG. 1, the HVAC component(s) 6 may provide heated air (and/or cooled air) via the ductwork throughout the building 2. As illustrated, the HVAC component(s) 6 may be in fluid communication with every room and/or zone in the building 2 via the ductwork 10 and 14, but this is not required. In operation, when a heat call signal is provided by the HVAC controller(s) 18, an HVAC component 6 (e.g. forced warm air furnace) may be activated to supply heated air to one or more rooms and/or zones within the building 2 via supply air ducts 10. The heated air may be forced through supply air duct 10 by a blower or fan 22. In this example, the cooler air from each zone may be returned to the HVAC component 6 (e.g. forced warm air furnace) for heating via return air ducts 14. Similarly, when a cool call signal is provided by the HVAC controller(s) 18, an HVAC component 6 (e.g. air conditioning unit) may be activated to supply cooled air to one or more rooms and/or zones within the building or other structure via supply air ducts 10. The cooled air may be forced through supply air duct 10 by the blower or fan 22. In this example, the warmer air from each zone may be returned to the HVAC component 6 (e.g. air conditioning unit) for cooling via return air ducts 14.

In some cases, the system of vents or ductwork 10 and/or 14 can include one or more dampers 24 to regulate the flow of air, but this is not required. For example, one or more dampers 24 may be coupled to one or more HVAC controller(s) 18, and can be coordinated with the operation of one or more HVAC components 6. The one or more HVAC controller(s) 18 may actuate dampers 24 to an open position, a closed position, and/or a partially open position to modulate the flow of air from the one or more HVAC components to an appropriate room and/or zone in the building or other structure. The dampers 24 may be particularly useful in zoned HVAC systems, and may be used to control which zone(s) receives conditioned air from the HVAC component(s) 6.

In many instances, one or more air filters 30 may be used to remove dust and other pollutants from the air inside the building 2. In the illustrative example shown in FIG. 1, the air filter(s) 30 is installed in the return air duct 14, and may filter the air prior to the air entering the HVAC component 6, but it is contemplated that any other suitable location for the air filter(s) 30 may be used. The presence of the air filter(s) 30 may not only improve the indoor air quality, but may also protect the HVAC components 6 from dust and other particulate matter that would otherwise be permitted to enter the HVAC component.

In some cases, and as shown in FIG. 1, the illustrative HVAC system 4 may include an equipment interface module (EIM) 34. When provided, the equipment interface module 34 may be configured to measure or detect a change in a given parameter between the return air side and the discharge air side of the HVAC system 4. For example, the equipment interface module 34 may be adapted to measure a difference in temperature, flow rate, pressure, or a combination of any one of these parameters between the return air side and the discharge air side of the HVAC system 4. In some cases, the equipment interface module 34 may be adapted to measure the difference or change in temperature (delta T) between a return air side and discharge air side of the HVAC system 4 for the heating and/or cooling mode. The delta T for the heating mode may be calculated by subtracting the return air temperature from the discharge air temperature (e.g. delta T=discharge air temp.−return air temp.). For the cooling mode, the delta T may be calculated by subtracting the discharge air temperature from the return air temperature (e.g. delta T=return air temp.−discharge air temp.).

In some cases, the equipment interface module 34 may include a first temperature sensor 38a located in the return (incoming) air duct 14, and a second temperature sensor 38b located in the discharge (outgoing or supply) air duct 10. Alternatively, or in addition, the equipment interface module 34 may include a differential pressure sensor including a first pressure tap 39a located in the return (incoming) air duct 14, and a second pressure tap 39b located downstream of the air filter 30 to measure a change in a parameter related to the amount of flow restriction through the air filter 30. In some cases, the equipment interface module 34, when provided, may include at least one flow sensor that is capable of providing a measure that is related to the amount of air flow restriction through the air filter 30. In some cases, the equipment interface module 34 may include an air filter monitor. These are just some examples.

When provided, the equipment interface module 34 may be configured to communicate with the HVAC controller 18 via, for example, a wired or wireless communication link 42. In other cases, the equipment interface module 34 may be incorporated or combined with the HVAC controller 18. In either cases, the equipment interface module 34 may communicate, relay or otherwise transmit data regarding the selected parameter (e.g. temperature, pressure, flow rate, etc.) to the HVAC controller 18. In some cases, the HVAC controller 18 may use the data from the equipment interface module 34 to evaluate the system's operation and/or performance. For example, the HVAC controller 18 may compare data related to the difference in temperature (delta T) between the return air side and the discharge air side of the HVAC system 4 to a previously determined delta T limit stored in the HVAC controller 18 to determine a current operating performance of the HVAC system 4.

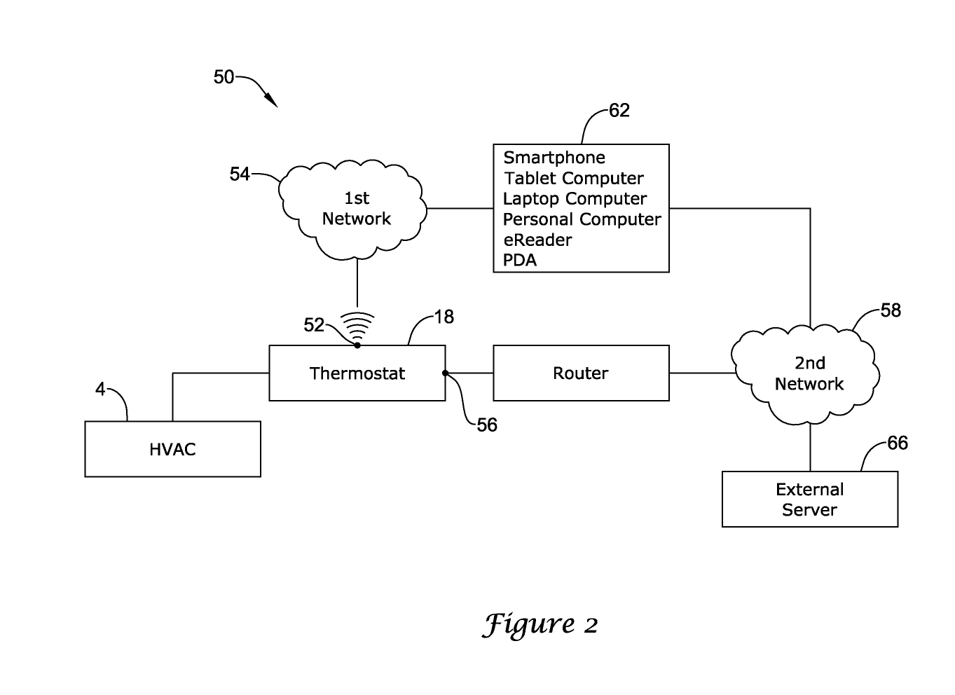

FIG. 2 is a schematic view of an illustrative HVAC control system 50 that facilitates remote access and/or control of the HVAC system 4 shown in FIG. 1. The illustrative HVAC control system 50 includes an HVAC controller, such as for example, HVAC controller 18 (see FIG. 1) that is configured to communicate with and control one or more components 6 of the HVAC system 4. As discussed above, the HVAC controller 18 may communicate with the one or more components 6 of the HVAC system 4 via a wired or wireless link. Additionally, the HVAC controller 18 may be adapted to communicate over one or more wired or wireless networks that may accommodate remote access and/or control of the HVAC controller 18 via another device including, but not limited to, mobile phones including smart phones, PDAs, tablet computers, laptop or personal computers, e-Readers, and/or the like.

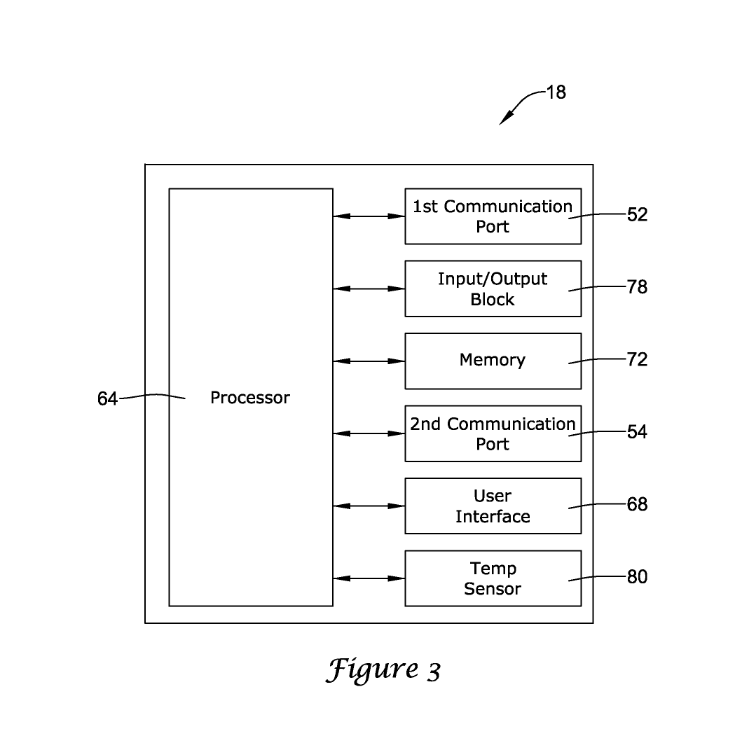

As shown in FIG. 2 and FIG. 3, the HVAC controller 18 may include a first input/output port 52 for communicating over a first network 54, and in some cases, a second input/output port 56 for communicating over a second network 58. In some cases, the first network 54 (when provided) may be a wireless local area network (LAN), and the second network 58 (when provided) may be a telecommunications network, cellular network, a wide area network or global network (WAN) including, for example, the Internet. In some cases, the wireless local area network 54 may provide a wireless access point and/or a network host device that is separate from the HVAC controller 18. In other cases, the wireless local area network 54 may provide a wireless access point and/or a network host device that is part of the HVAC controller 18. In some cases, the wireless local area network 54 may include a local domain name server (DNS), but this is not required for all embodiments. Additionally, in some cases, the wireless local area network 54 may be an ad-hoc wireless network, but this is not required.

Depending upon the application and/or where the HVAC user is located, remote access and/or control of the HVAC controller 18 may be provided over the first network 54 and/or the second network 58. A variety of remote devices 62 may be used to access and/or control the HVAC controller 18 from a remote location (e.g. remote from HVAC Controller 18) over the first network 54 and/or second network 58 including, but not limited to, mobile phones including smart phones, PDAs, tablet computers, laptop or personal computers, e-Readers, and/or the like. In many cases, the remote devices 62 may be configured to communicate wirelessly over the first network 54 and/or second network 58 with the HVAC controller 18 via one or more wireless communication protocols including, but not limited to, cellular communication, ZigBee, REDLINK™, Bluetooth, WiFi, IrDA, dedicated short range communication (DSRC), EnOcean, and/or any other suitable common or proprietary wireless protocol, as desired. In some cases, the remote devices 62 may include a wired device, such as a personal computer or other device with a wired connection to the first network 54 and/or second network 58.

In some cases, the HVAC controller 18 may be programmed to communicate over the second network 58 with an external web service hosted by one or more external web servers 66. A non-limiting example of such an external web service is Honeywell's TOTAL CONNECT™ web service. The HVAC controller 18 may be configured to upload selected data via the first network 54 and/or second network 58 to the external web service where it may be collected and stored on the external web server 66. In some cases, the data may be indicative of the performance of the HVAC system 4. Additionally, the HVAC controller 18 may be configured to send and/or receive selected data, configuration information, settings and/or services including software updates from the external web service over the first network 54 and/or second network 58. The data, configuration information, settings and/or services may be sent and/or received automatically, periodically in accordance with a control algorithm, and/or on demand in response to a user request. In some cases, for example, the HVAC controller 18 may be configured to send and/or receive an HVAC operating schedule and operating parameter settings such as, for example, temperature set points, humidity set points, start times, end times, schedules, window frost protection settings, and/or the like. In some instances, the HVAC controller 18 may be configured to receive one or more user profiles having at least one operational parameter setting that is selected by and reflective of a user's preferences. Additionally, the HVAC controller 18 may be configured to receive local weather data, weather alerts and/or warnings, major stock index ticker data, and/or news headlines over the second network 58. In some cases, the HVAC controller 18 may be configured to publish in a computer readable form a configuration parameter data package, as further described below. These are just some examples.

FIG. 3 is a schematic view of an illustrative HVAC controller 18 that may be accessed and/or controlled from a remote location over the first network 54 and/or the second network 58 (FIG. 2) using, for example, a remote device 62 such as, for example, a smart phone, a PDA, a tablet computer, a laptop or personal computer, an e-Reader, and/or the like. In some instances, the HVAC controller 18 may be a thermostat, but this is not required. As shown in FIGS. 2 and 3, the illustrative HVAC controller 18 may include a first input/output port 52 for communicating over a first network (e.g. wireless LAN) and/or a second input/output port 56 for communicating over a second network (e.g. WAN or the Internet). The first input/output port 52 can be a wireless input/output port including a wireless transceiver for wirelessly sending and/or receiving signals over a first wireless network 54. The second input/output port 56 may be a wireless input/output port including a wireless transceiver for sending and/or receiving signals over a second wireless network 58. In some cases, the second input/output port 56 may be in communication with a wired or wireless router or gateway for connecting to the second network, but this is not required. The router or gateway may be integral to the HVAC controller 18 or may be provided as a separate device.

The illustrative HVAC controller 18 includes a processor (e.g. microprocessor, microcontroller, etc.) 64 coupled to the input/output ports 52, 56, and a memory 72. The HVAC controller 18 may also include a user interface 68 accessible at the HVAC controller 18, but this is not required. The memory 72 of the illustrative HVAC controller 18 may be in communication with the processor 64. The memory 72 may be used to store any desired information, such as the aforementioned control algorithm, set points, schedule times, diagnostic limits such as, for example, differential pressure limits, delta T limits, configuration information, and the like. The memory 72 may be any suitable type of storage device including, but not limited to, RAM, ROM, EPROM, flash memory, a hard drive, and/or the like. In some cases, the processor 64 may store information within the memory 72, and may subsequently retrieve the stored information from the memory 72.

In some cases, the HVAC controller 18 may also include a timer (not shown). The timer may be integral to the processor 64 or may be provided as a separate component. The HVAC controller 18 may also optionally include an input/output block (I/O block) 78 for receiving one or more signals from the HVAC system 4 and/or for providing one or more control signals to the HVAC system 4. For example, the I/O block 78 may communicate with one or more HVAC components 6 of the HVAC system 4. Alternatively, or in addition to, the I/O block 78 may communicate with another controller, which is in communication with one or more HVAC components of the HVAC system 4, such as a zone control panel in a zoned HVAC system, equipment interface module (EIM) (e.g. EIM 34 shown in FIG. 1) or any other suitable building control device.

The HVAC controller 18 may also include an internal temperature sensor 80. In addition or in alternative to, the HVAC controller 18 may communicate with one or more remote temperature sensors, humidity sensors, and/or occupancy sensors located throughout the building or structure. In some cases, for example, the HVAC controller 18 may communicate with a temperature sensor and/or humidity sensor located outside of the building or structure for sensing an outdoor temperature and/or humidity if desired.

During normal and/or routine operation, the processor 64 may operate in accordance with an algorithm that controls or at least partially controls one or more HVAC components of an HVAC system such as, for example, HVAC system 4 shown in FIG. 1. The processor 64, for example, may operate in accordance with a control algorithm that provides temperature set point changes, humidity set point changes, schedule changes, start and end time changes, window frost protection setting changes, operating mode changes, and/or the like. At least a portion of the control algorithm may be stored locally in the memory 72 of the HVAC controller 18 and, in some cases, may be received from an external web service over the second network. The control algorithm (or portion thereof) stored locally in the memory 72 of the HVAC controller 18 may be periodically updated in accordance with a predetermined schedule (e.g. once every 24 hours, 48 hours, 72 hours, weekly, monthly, etc.), updated in response to any changes to the control algorithm made by a user, and/or updated in response to a user's request. The updates to the control algorithm or portion of the control algorithm stored in the memory 72 may be received from an external web service 66 over the second network 58. In some cases, the control algorithm may include settings such as set points, configuration parameters and the like.

In some cases, the processor 64 may operate according to a first operating mode having a first temperature set point, a second operating mode having a second temperature set point, a third operating mode having a third temperature set point, and/or the like. In some cases, the first operating mode may correspond to an occupied mode and the second operating mode may correspond to an unoccupied mode. In some cases, the third operating mode may correspond to a holiday or vacation mode wherein the building or structure in which the HVAC system 4 is located may be unoccupied for an extended period of time. In other cases, the third operating mode may correspond to a sleep mode wherein the building occupants are either asleep or inactive for a period of time. These are just some examples. It will be understood that the processor 64 may be capable of operating in additional modes as necessary or desired. The number of operating modes and the operating parameter settings associated with each of the operating modes may be established locally through a user interface, and/or through an external web service and delivered to the HVAC controller via the second network 58 where they may be stored in the memory 72 for reference by the processor 64.

In the illustrative embodiment of FIG. 3, the user interface 68, when provided, may be any suitable user interface that permits the HVAC controller 18 to display and/or solicit information, as well as accept one or more user interactions with the HVAC controller 18. For example, the user interface 68 may permit a user to locally enter data such as temperature set points, humidity set points, starting times, ending times, schedule times, diagnostic limits, responses to alerts, configuration parameter value selections, and/or the like. In one embodiment, the user interface 68 may be a physical user interface that is accessible at the HVAC controller 18, and may include a display and/or a distinct keypad. The display may be any suitable display. In some instances, a display may include or may be a liquid crystal display (LCD), and in some cases a fixed segment display or a dot matrix LCD display. In other cases, the user interface 68 may be a touch screen LCD panel that functions as both display and keypad. The touch screen LCD panel may be adapted to solicit values for a number of operating parameters and/or to receive such values, but this is not required. In still other cases, the user interface 68 may be a dynamic graphical user interface.

In some instances, the user interface 68 need not be physically accessible to a user at the HVAC controller 18. Instead, the user interface 68 may be a virtual user interface 68 that is accessible via the first network 54 and/or second network 58 using a remote device such as one of those devices previously described herein. In some cases, the virtual user interface 68 may include and display HVAC controller related information. The HVAC controller related information may relate to the overall configuration and setup of the HVAC system 4. The HVAC controller related information may be displayed by one or more web pages that are broadcasted over the first network 54 (e.g. LAN) by an internal web server implemented by the processor 64. When so provided, the virtual user interface 68 may be accessed over the first network 54 using a remote device 62 such as any one of those listed above. Through the one or more web pages, the processor 64 may be configured to display information relevant to the current operating status of the HVAC system 4 including the current operating mode, temperature set point, actual temperature within the building, outside temperature, outside humidity, available configuration parameter values for one or more configuration parameters, and/or the like. Additionally, the processor 64 may be configured to receive and accept user inputs entered via the virtual user interface 68 including temperature set points, humidity set points, starting times, ending times, schedule times, configuration parameter value selections, window frost protection settings, diagnostic limits, responses to alerts, and/or the like.

In some cases, the virtual user interface 68 may include one or more web pages that are broadcasted over the second network 58 (e.g. WAN or the Internet) by an external web server (e.g. web server 66). The one or more web pages may contain HVAC controller related information including the current operating mode, temperature set point, actual temperature within the building, outside temperature, outside humidity, available configuration parameter values for one or more configuration parameters, and/or the like. The one or more web pages forming the virtual user interface 68 may be hosted by an external web service and associated with a user account having one or more user profiles. The external web server 66 may receive and accept any user inputs entered via the virtual user interface and associate the user inputs with a user's account on the external web service. If the user inputs include any changes to the existing control algorithm including any temperature set point changes, humidity set point changes, schedule changes, start and end time changes, window frost protection setting changes, operating mode changes, configuration parameter value changes, and/or changes to a user's profile, the external web server may update the control algorithm, as applicable, and transmit at least a portion of the updated control algorithm over the second network 58 to the HVAC controller 18 where it is received via the second input/output port 56 and may be stored in the memory 72 for execution by the processor 64. In some cases, the information that is displayed on the one or more web pages forming the virtual user interface 68 may relate to the overall configuration and setup of the HVAC system 4.

Upon installation of the HVAC controller 18, the processor 64 may be configured to publish at least a first configuration parameter data package related to setting up and configuring the HVAC controller 18 for operation. The first configuration parameter data package may be published in a computer readable form and may be transmitted over the first and/or second networks 54, 58 to a remote device 62 where the information contained within the first parameter data package may be displayed to the user via the user interface of the remote device 62. The computer readable form may include any number of computer readable languages that may be interpreted and executed by a processor (e.g. microcontroller, microprocessor, etc.) of the remote device 62 that receives the configuration parameter data package including, but not limited to the following: html, xhtml, xml, binary, and/or any other suitable computer readable form. In some cases, the first configuration parameter data package may include a text string for natural language programming. The text string may cause the remote device 62 to display at least some of the information contained within the configuration parameter data package in a natural language format that may be easy and intuitive for a user to understand.

The configuration parameter data package(s) may relate to any number of configuration parameters for setting up and configuring the HVAC controller 18. The number and type of configuration parameters used to configure the HVAC controller 18 may be largely dependent on the number and type of HVAC components 6 forming the HVAC system 4, as well the functionality and options offered by the particular model of the HVAC controller 18. Exemplary configuration parameters may include, but are not limited to, the following: heating system type (e.g. convention forced air, heat pump, radiant heat, etc.), heating equipment type (e.g. standard efficiency forced air, high efficiency forced air, hot water fan coil, etc.), cooling equipment type, the number of equipment stages for heating and/or cooling, temperature control options, number and/or type of remote sensors, number and/or type of air filters, the minimum operating time desired to operate the system, whether a heat pump exercise is to be enabled for any installed heat pumps, the upper temperature limit at which to operate the system, the lower temperature limit at which to operate the system, the temperature offset at which the controller operates, the proportional bandwidth of the equipment, the type and operating times of a ventilation fan employed, the type and rating of a UV lamp employed, the type and rating of a humidifier or dehumidifier employed, and/or the like. Some configuration parameters may relate to a user's preference, and may include, but are not limited to, the following: the display language, temperature indication scale (e.g. Fahrenheit or Celsius), the date and time format, daylight savings options, schedule programming options, temperature display options, and/or the like.

A first configuration data package published and transmitted by the HVAC controller 18 over the first and/or second networks 54, 58 may include a first configuration parameter identifier identifying a configuration parameter of the HVAC controller 18, and information regarding configuration parameter values associated with the first configuration parameter identifier that are available for selection by the user. In some cases, the first configuration data package may include a valid range of parameter values associated with the first configuration parameter and, in some cases, may include one or more valid steps for change within the valid range. In some instances, the first configuration data package may include the current or default parameter value of the first configuration parameter, but this is not required. The first configuration data package may include one or more rules relating to an interdependency between a first configuration parameter and a subsequent configuration parameter. For example, if the first configuration parameter relates to a heating equipment type, then the second configuration parameter may relate to a number of stages of the heating equipment type. In some cases, the one or more rules may relate to or define an interdependency between the available parameter values for a first configuration parameter and the available parameter values for a second configuration parameter. In some cases, the one or more rules may relate to or define an interdependency between the available parameter values for the first configuration parameter and a second configuration parameter.

In some instances, a first configuration parameter data package may include at least one additional configuration parameter identifier for at least one additional configuration parameter and information regarding available parameter values for the additional configuration parameter. The first configuration parameter data package may include one or more rules relating to an interdependency between the first configuration parameter and the additional configuration parameter and, in some cases, may further include one or more rules relating to an interdependency between the available parameter values for the first configuration parameter and the additional configuration parameter or one or more rules relating to an interdependency between the available parameter values for the first configuration parameter and the available parameter values for the additional configuration parameter.

Once the first configuration parameter data package has been published, the HVAC controller 18 may be configured to receive a first configuration parameter value selected by a user from the available parameter values associated with the first configuration parameter via the first network and/or second networks 54, 58. The HVAC controller 18 may set the parameter value of the first configuration parameter to the first parameter value selected by the user for use by the control algorithm that is executed during subsequent operation of the HVAC controller 18.

In many cases, the HVAC controller 18 may be configured to publish and transmit at least one additional configuration parameter data package to the remote device 62. The additional configuration parameter data package may be dependent, at least in part, on the selected parameter value associated with a first configuration data package received from the user. For example, the HVAC controller 18 may be configured to select a particular one of a plurality of configurations of the HVAC controller 18 to publish as part of the additional configuration parameter data package in response to the first configuration parameter value selected by the user and received by the HVAC controller 18. In some cases, selection of a particular one of a plurality of configuration parameters of the HVAC controller 18 may depend on one or more rules stored in the memory of the HVAC controller 18. The one or more rules may relate to or define an interdependency between the first configuration parameter value selected by the user and received by the HVAC controller 18 and the additional configuration parameter. In some cases, the one or more rules relating to or defining the interdependency between the available parameter values for the first configuration parameter and an additional configuration parameter may be included in the first configuration parameter package published by the HVAC controller 18 and transmitted to the remote device 62, but this is not required. The HVAC controller 18 may be configured to publish and transmit additional configuration parameter data packages in response to a user's selection(s) associated with a previously published configuration data package until configuration and setup of the HVAC controller 18 is complete.

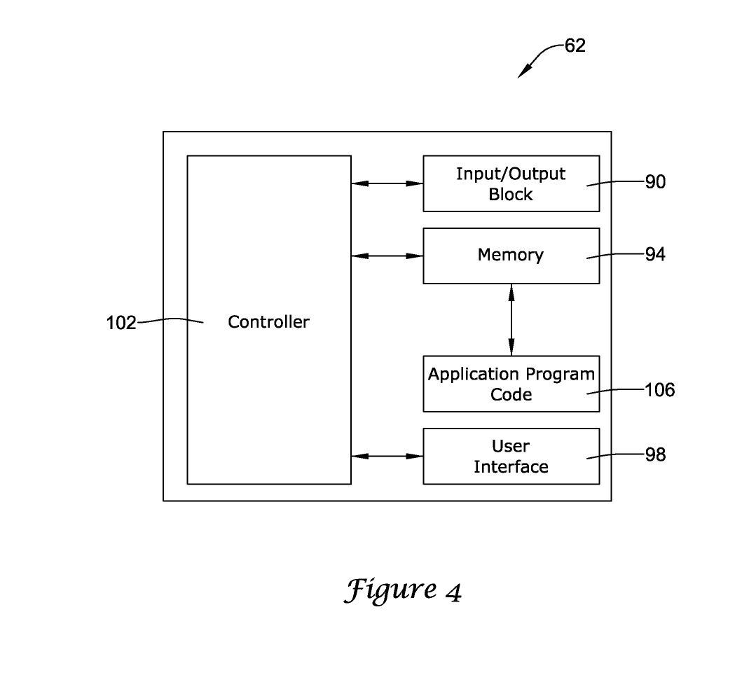

FIG. 4 is a schematic block diagram of a remote device 62 that may be used to communicate with and/or control one or more HVAC controllers 18 located within a building or structure 2. The remote device 62 may be, for example, any one of the devices described herein. In some instances, the remote device 62 may be a smartphone or a tablet computer, but this is not required. As discussed above with reference to FIG. 2, the remote device 62 may be used to communicate with and/or configure one or more HVAC controllers 18 located within the building or structure 2 via the first network 54 and/or second network 58 depending upon the application. In some cases, as described herein, the remote device 62 may be programmed to communicate over the second network 58 with an external web service hosted by one or more external web servers 66 to which the HVAC controller 18 is also connected. A non-limiting example of such an external web service is Honeywell's TOTAL CONNECT™ web service. When so provided, communication and data may be transmitted between the remote device 62 and the one or more HVAC controllers 18 via the external web service hosted by the one or more external web servers 66.

As shown in FIG. 4, the remote device 62 may include at least one wired and/or wireless input/output port 90 for sending and/or receiving data over the first and/or second network 54, 58 to and from the one or more HVAC controllers 18 located within the building 2. The illustrative remote device 62 may include a memory 94, a user interface 98 including a display, and a controller 102 (e.g. microprocessor, microcontroller, etc.) coupled to the input/output port 90, the memory 94, and the user interface 98. In some instances, one or more application program codes 106 may be stored in the memory 94 for execution by the controller 102 of the remote device 62. In some instances, the one or more application program codes 106 may be purchased and/or downloaded from an external web service such as, for example, Apple, Inc.'s ITUNES™, Google Inc.'s Google Play, and/or from some other external web service hosted by one or more external web servers 66 to which the one or more HVAC controllers 18 can be connected. In one instance, at least one of the application program codes 106 stored in the memory 94 may relate to controlling an HVAC system 4. In some instances, at least one of the application program codes 106 stored in the memory 94 may relate to configuring the HVAC system 4 upon initial setup and installation of the HVAC system. The application code 106 related to configuring the HVAC system 4 may also be used to make changes to the HVAC system 4 configuration at any time during the operation of the HVAC system 4. In some cases, the controller 102 of the remote device 62 may be capable of executing multiple application program codes 106 stored in the memory 94 for carrying out different functions.

In some cases, when the remote device 62 is in communication with an HVAC controller such as, for example, HVAC controller 18 as described herein, the application program code 106 may enable the remote device 62 to receive at least a first configuration parameter package for configuring the HVAC controller 18 via the first and/or second network 54, 58, sometimes without the remote device 62 first specifically requesting from the HVAC controller 18 data related to a first configuration parameter. The application program code 106 may cause the remote device 62 to display one or more screens (sometimes web pages) on the user interface 98 of the remote device 62 that solicit input from the user to select a value for a first configuration parameter of the HVAC controller 18. The remote device 62 may receive a first configuration parameter value selected by a user through the user interface 98 of the remote device 62, and in response, may transmit the selected first configuration parameter value over the first and/or second network 54, 58 to the HVAC controller 18.

In some cases, the application program code 106 may enable the remote device 62 to receive at least one additional configuration parameter package related to configuring the HVAC controller 18 via the first and/or second network 54, 58, sometimes without the remote device 62 specifically requesting from the HVAC controller 18 data related to the additional configuration parameter. For example, in some instances, the HVAC controller 18 may automatically transmit at least one additional configuration parameter package related to configuring the HVAC controller 18 in response to receiving the value selected by the user for the first configuration parameter and transmitted to the HVAC controller 18 from the remote device 62. As described herein, the information contained within the additional configuration parameter package related to configuring the HVAC controller 18 may be dependent upon the first configuration parameter value selected by the user for the first configuration parameter. The application program code 106 may cause the remote device 62 to display one or more screens (sometimes web pages) on the user interface 98 of the remote device 62 that solicit input from the user to select a configuration parameter value in connection with the additional configuration parameter package received from the HVAC controller 18. The remote device 62 may receive an additional configuration parameter value in connection with the additional configuration parameter package from the user, and in response, may transmit the selected additional configuration parameter value over the first and/or second network 54, 58 to the HVAC controller 18. The application program code 106 may cause the remote device 62 to continue to execute the steps described above for configuring the HVAC controller 18 until the configuration process is completed or exited.

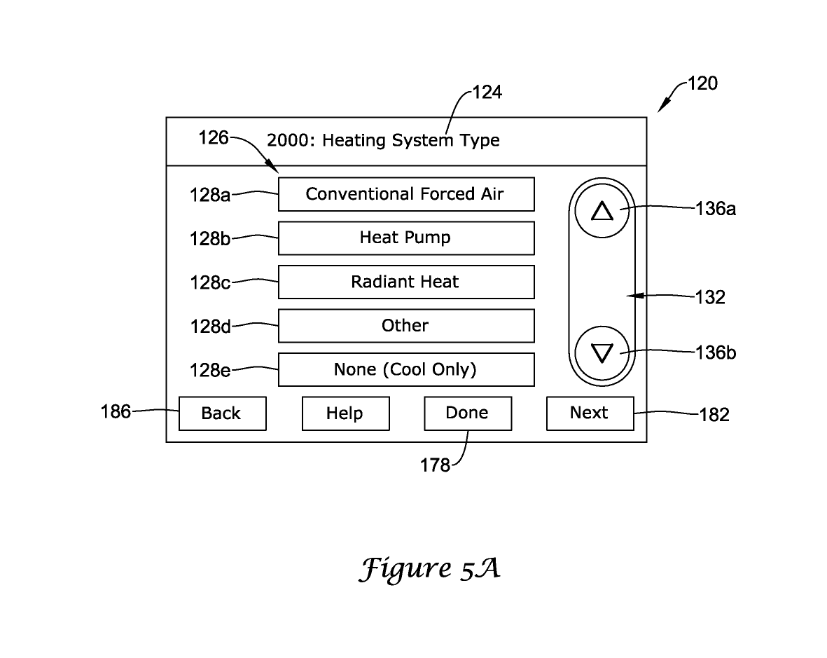

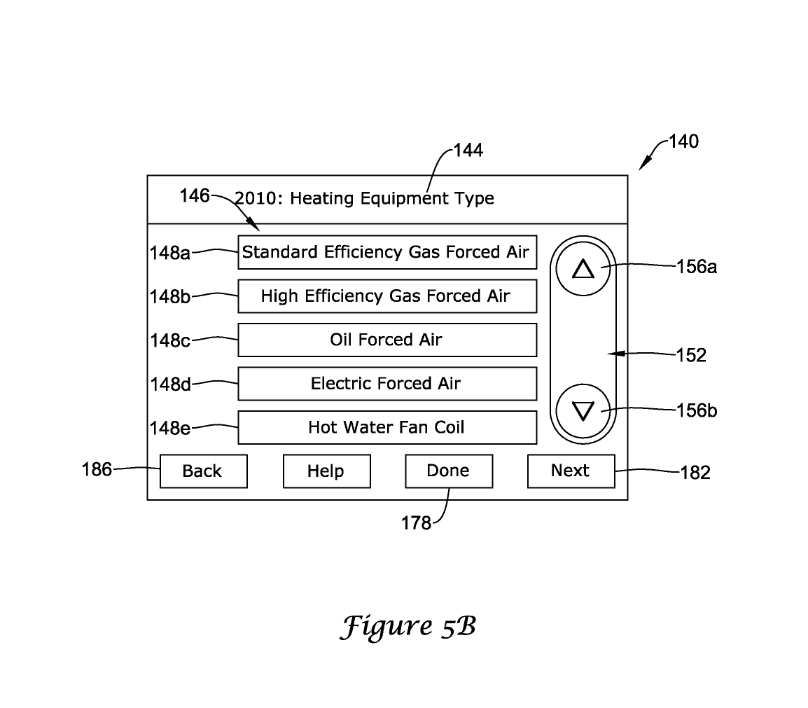

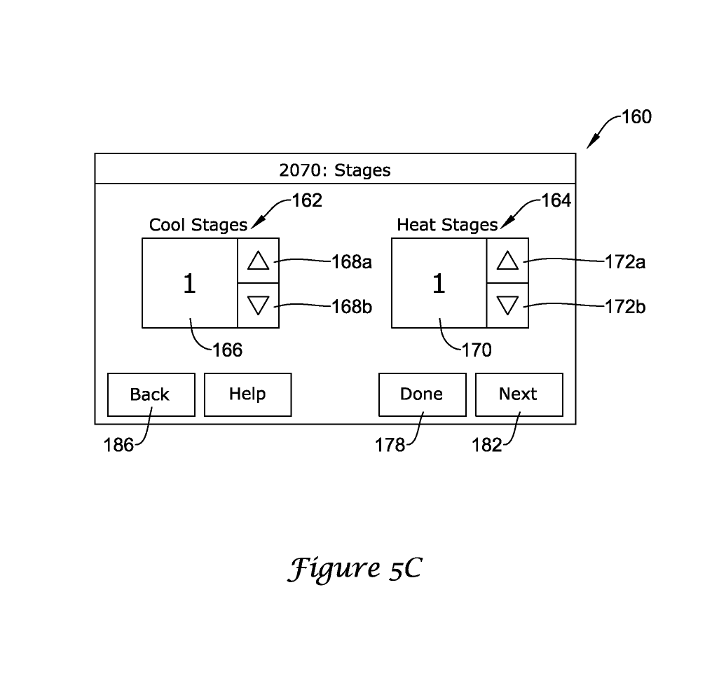

FIGS. 5A-10 show exemplary screens that may be displayed by the user interface 98 of a remote device to setup and/or configure an HVAC controller, such as HVAC controller 18. The illustrative screens include several exemplary interview questions and choices for responding to those questions related to the setup and/or configuration of the HVAC controller 18. The interview questions and response choices presented to the user are representative of different configuration data packages that may be published by the HVAC controller 18 and transmitted to the remote device 62 over the first and/or second networks 54, 58. The configuration data packages may include a configuration parameter identifier identifying a configuration parameter of the HVAC controller 18 and information regarding configuration parameter values associated with the displayed configuration parameter identifier that are available for selection by the user. The interview questions and response choices representative of the configuration data packages may be provided in a natural language format that may be easy and intuitive for a user to follow and understand, but this is not required. When so provided, the interview questions and the allowable answers may guide the user through the setup and/or configuration process of the HVAC controller 18.

As described herein, the remote device 62 may receive a first configuration parameter package from the HVAC controller 18 in a computer readable form. In response, the application program code 106 stored in the memory 94 of the remote device may cause the controller 102 to display the first configuration parameter package received from the HVAC controller as one or more screens (sometimes web pages) on the user interface 98 of the remote device 62. In the illustrative example of FIG. 5A, screen 120 is representative of at least part of a first configuration parameter package transmitted by the HVAC controller 18 and received by the remote device 62, and relates to a heating system type parameter. Screen 120 may include a configuration parameter identifier 124 identifying the first configuration parameter (e.g. heating system type), and a table 126 including one or more available parameter values 128a-128e associated with the identified first configuration parameter, which are shown available for selection by a user of the remote device. In some cases, the table 126 may be a scrolling table, in which case, screen 120 may also include a scroll bar 132 including first and second arrows 136a, 136b that may facilitate a user in scrolling through the available parameter values. As shown in FIG. 5A, the available parameter values 128a-128e may correspond to different heating system types (e.g. conventional forced air, heat pump, radiant heat, none (cool only), other, etc.). Upon selection of a parameter value such as, for example, parameter value 128a corresponding to a conventional forced air heating system type, the application program code 106 may cause the remote device 62 to transmit the selected parameter value to the HVAC controller 18 via the first or second network 54, 58.

In some cases, the HVAC controller 18 may then automatically transmit a second configuration data package to the remote device 62 where the information contained with the second configuration data package may be displayed on the user interface 98 of the remote device 62. In some cases, as described herein, the second configuration parameter data package may be dependent upon the user's selection of a first configuration parameter value.

In the illustrative example shown in FIG. 5B, screen 140 is representative of a second configuration parameter data package transmitted by the HVAC controller 18 in response to the user's selection of first parameter value 128a, which identifies a conventional forced air heating system type. Like screen 120, screen 140 may include a configuration parameter identifier 144 identifying the second configuration parameter (e.g. heating equipment type). Additionally, screen 140 may include a table 146 displaying one or more available parameter values 148a-148e associated with the identified second configuration parameter value that are available for selection by a user. In some cases, the table 146 may be a scrolling table, in which case, screen 140 may also include a scroll bar 152 including first and second arrows 156a, 156b that may facilitate a user in scrolling through the available second parameter values 148a-148e. As shown in FIG. 5B, the available parameter values 148a-148e may correspond to different heating equipment types (e.g. standard efficiency gas forced air, high efficiency gas forced air, oil forced air, electronic forced air, hot water fan coil, etc.). Upon selection of a second parameter value, such as for example parameter value 148a, which corresponds to a standard efficiency gas forced air heating equipment type, the application program code 106 may cause the remote device 62 to transmit the user's selected parameter value to the HVAC controller 18 via the first or second network 54, 58. In response, the HVAC controller 18 may transmit an additional configuration parameter data package to the remote device 62, where the information contained with the additional configuration parameter data package may be displayed on the user interface 98 of the remote device 62, and in some cases may be dependent upon the user's selection of the second configuration parameter value.

FIG. 5C provides an illustrative screen 160 that is representative of an additional configuration parameter data package that may be transmitted by the HVAC controller 18 in response to the user's selection of second parameter value 148a, which corresponds to a standard efficiency gas forced air heating equipment type. In the illustrative example of FIG. 5C, screen 160 is representative of the additional configuration parameter data package received from the HVAC controller 18, and includes a first configuration parameter identifier 162 identifying a first configuration parameter (e.g. cool stages) and a second configuration parameter 164 identifying a second configuration parameter (e.g. heat stages). Screen 160 also includes a first box 166 displaying the current or default number of cooling stages and first and second arrows 168a, 168b for selecting the number of cooling stages from a valid range of cooling stages, and a second box 170 displaying the current or default number of heating stages and third and fourth arrows 172a, 172b for selecting the number of heating stages from a valid range of heating stages. Once selected, the remote device 62 may transmit the selected number of cooling and/or heating stages to the HVAC controller 18 via the first or second network 54 or 58. In response, the HVAC controller 18 may transmit yet another configuration parameter data package to the remote device 62, where the information contained with the additional configuration parameter data package may be displayed on the user interface 98 of the remote device 62, and in some cases, may be dependent upon the number of selected stages for cooling and/or heating.

In some cases, upon selection of a configuration parameter value, the user may either select the DONE button 178 or the NEXT button 182 displayed on any one of screens 120, 140, and/or 160 shown in FIGS. 5A-5C. Selection of either the DONE button 178 or the NEXT button may cause the remote device 62 to transmit the selected parameter value to the HVAC controller 18. In addition, selection of the DONE button 178 may cause the remote device 62 to exit the configuration set up process, while selection of the NEXT button, if provided, may cause the remote device 62 to continue with configuring the HVAC controller 18. A BACK button 186 may be provided on at least selected screens 120, 140, and/or 160, which may permit a user to return to a previous screen to verify or modify previous selections.

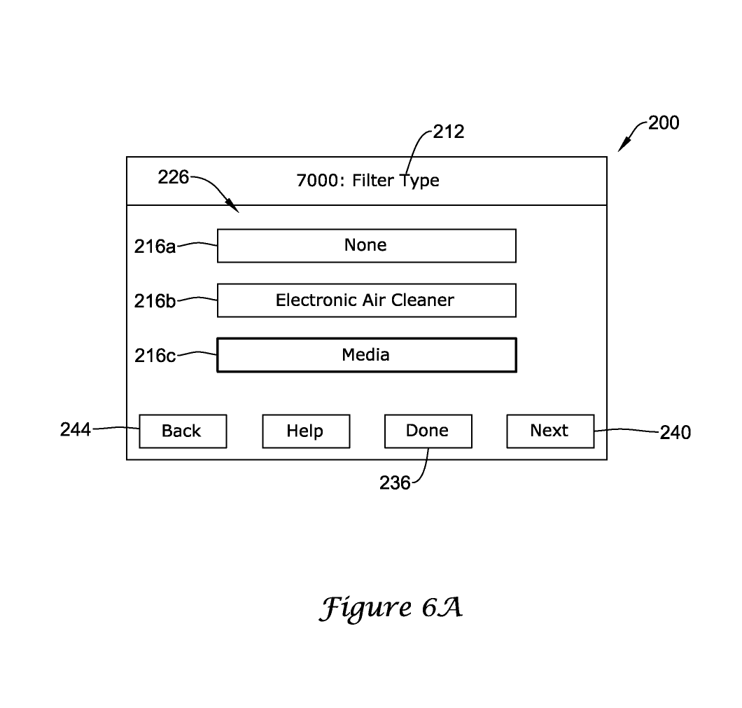

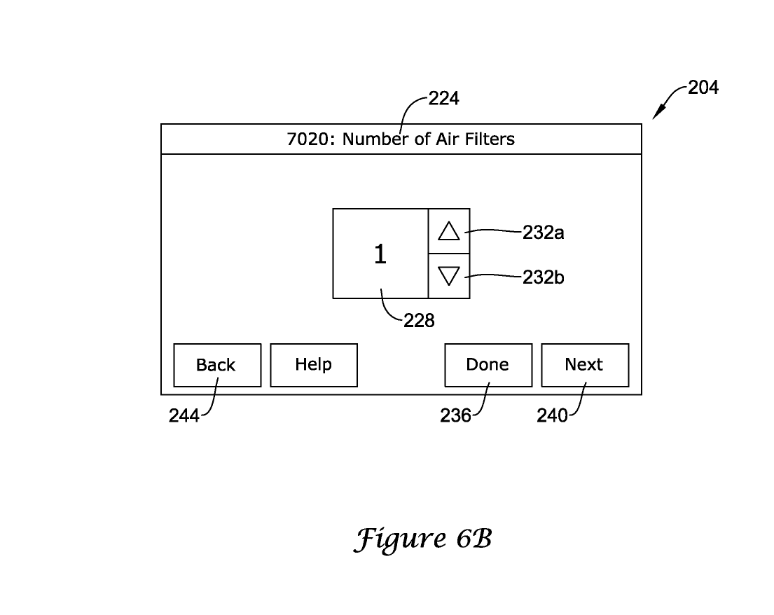

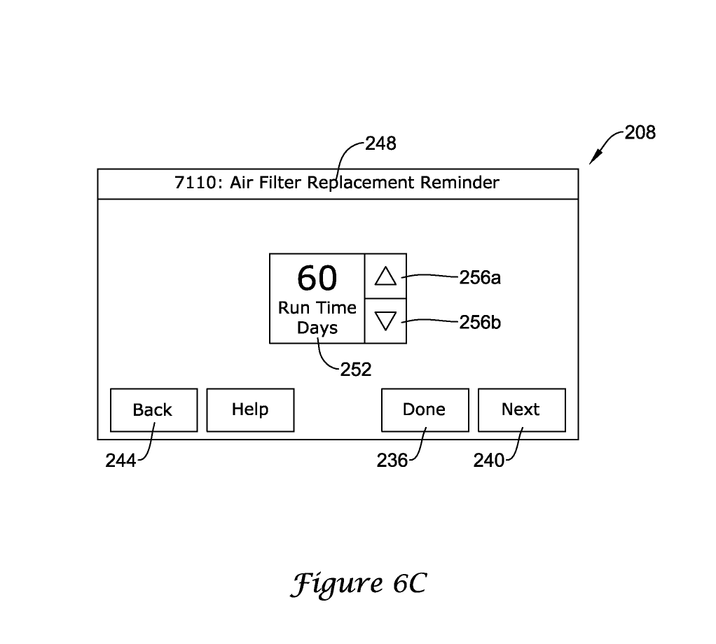

FIGS. 6A-10 show several illustrative screens that may be representative of additional configuration parameter data packages that may be transmitted by the HVAC controller 18 and received by the remote device 62 when configuring the HVAC controller 18. These are just some examples. It will be generally understood that the number and type of configuration parameters used to configure the HVAC controller 18 may be dependent on the number and type of HVAC components 6 forming the HVAC system 4, as well the functionality and options offered by the particular model of the HVAC controller 18.

Screens 200, 204, and 208 shown in FIGS. 6A-6C may be representative of configuration parameter data packages relating to a filter type, the number of air filters, and a reminder for replacing any air filters that may be used with the HVAC system 4. As shown in FIG. 6A, screen 200 may be representative of a configuration parameter data package associated with selecting a filter type. Screen 200 may include a configuration parameter identifier 212 and one or more parameter values 216a-216c (e.g. none, electronic air cleaner, media, etc.) available for selection by a user. The one or more parameter values 216a-216c may be displayed in a table 220, but this is not required.

In one example, upon selection of the parameter value 216c corresponding to a media filter, the remote device 62 may transmit the selected parameter value 216c to the HVAC controller 18. In response, the HVAC controller 18 may store the filter type selected by the user in the memory 72 of the HVAC controller 18 and may transmit a second configuration parameter data package to the remote device 62. At least one of the configuration parameters included in the second configuration data package transmitted by the HVAC controller 18 may be selected based, at least in part, on the user's previous selection, but this is not required.

Screen 204 shown in FIG. 6B is representative of an additional configuration data package relating to a number of air filters that may be transmitted by the HVAC controller 18 to the remote device in response to the user having selected the parameter value 216c in FIG. 6A. Screen 204 includes a configuration parameter identifier 224 and a box 228 displaying a number of air filters, and first and second arrows 232a, 232b for selecting the number of air filters present in the HVAC system 4. In some cases, upon selection of a number of air filters, the user may either select the DONE button 236 or the NEXT button 240. Selection of either the DONE button 236 or the NEXT button 240 may cause the remote device 62 to transmit the selected number of air filters to the HVAC controller 18 where the HVAC controller 18 may store the selected number of air filters in the memory 72. Selection of the DONE button 236 may cause the remote device 62 to exit the configuration set up process, while selection of the NEXT button, if provided, may cause the remote device 62 to continue with configuring the HVAC controller 18. A BACK button 244 may be provided, which may permit a user to return to a previous screen to verify or modify their previous selection.

Screen 208 shown in FIG. 6C is representative of yet another configuration data package relating to a reminder for replacing any air filters that is transmitted by the HVAC controller 18 to the remote device 62 in response to the user having selected the number of air filters in FIG. 6B. Screen 208 includes a configuration parameter identifier 248 and a box 252 displaying a number of day, and first and second arrows 256a, 256b for selecting the number of days that may pass before a reminder to replace the air filter is provided by the HVAC controller 18. In some cases, upon selection of the number of days that may pass before a reminder is provided, the user may either select the DONE button 236 or the NEXT button 240. Selection of either the DONE button 236 or the NEXT button 240 may cause the remote device 62 to transmit the selected number of days to the HVAC controller 18 where the HVAC controller 18 may store the selected number of days in the memory 72. Selection of the DONE button 236 may cause the remote device 62 to exit the configuration set up process, while selection of the NEXT button, if provided, may cause the remote device 62 to continue with configuring the HVAC controller 18. A BACK button 244 may also be provided which may permit a user to return to a previous screen to verify or modify their previous selection.

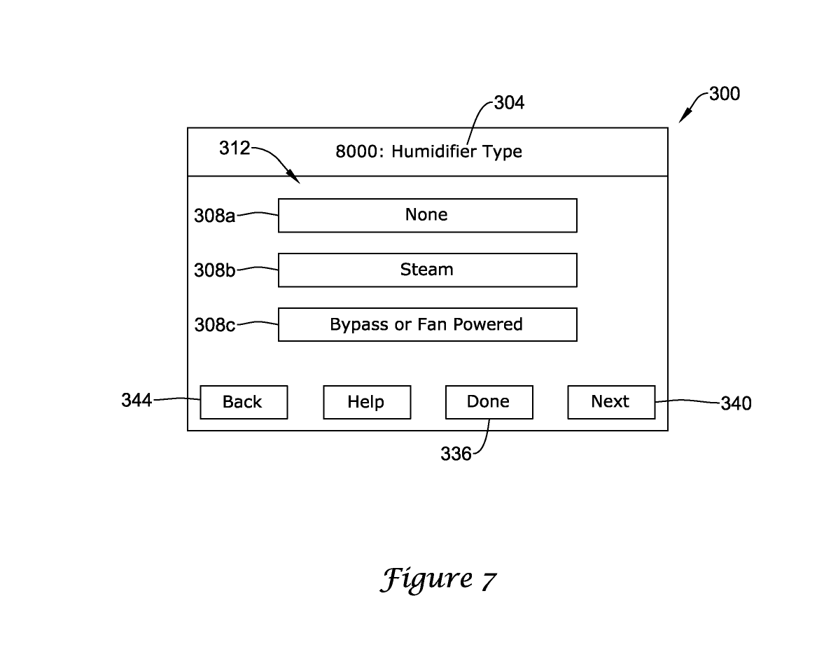

Screen 300 shown in FIG. 7 is representative of a configuration data package transmitted by the HVAC controller 18 to the remote device 62 relating to humidification equipment that may be included as a part of the HVAC system 4. Screen 300 includes a configuration parameter identifier 304, and one or more parameter values 308a-308c (e.g. none, steam, bypass or fan powered, etc.) available for selection by a user. The one or more parameter values 308a-308c may be displayed in a table 312, but this is not required. In one example, upon selection of the parameter value 308a, corresponding to “none” indicating that the HVAC system 4 does not include any humidification equipment, the remote device 62 may transmit the selected parameter value 308a to the HVAC controller 18. In response, the HVAC controller 18 may store the user's selection in the memory 72 of the HVAC controller 18 and may transmit a second configuration parameter data package to the remote device 62.

In some cases, the configuration parameters included in the second configuration data package transmitted by the HVAC controller 18 may be selected based, at least in part, on the user's previous selection. In this example, selection of the parameter value 308a corresponding to “none” transmitted by the remote device 62 and received by the HVAC controller 18 may cause the HVAC controller 18 not to transmit any additional configuration parameter data packages related to humidification equipment. Rather, the HVAC controller 18 may transmit an additional configuration data package relating to other HVAC equipment that may be included as part of the HVAC system 4, such as dehumidification equipment.

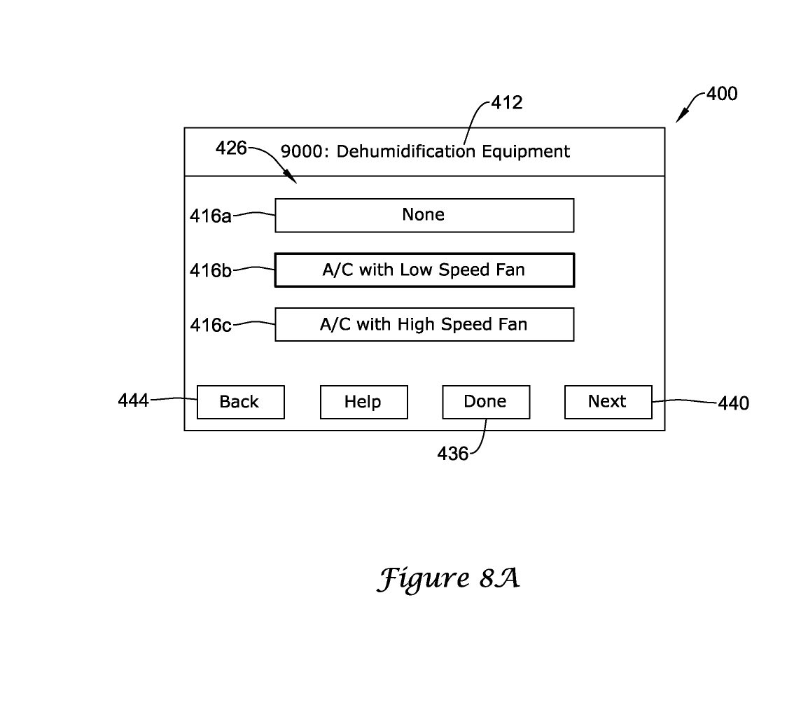

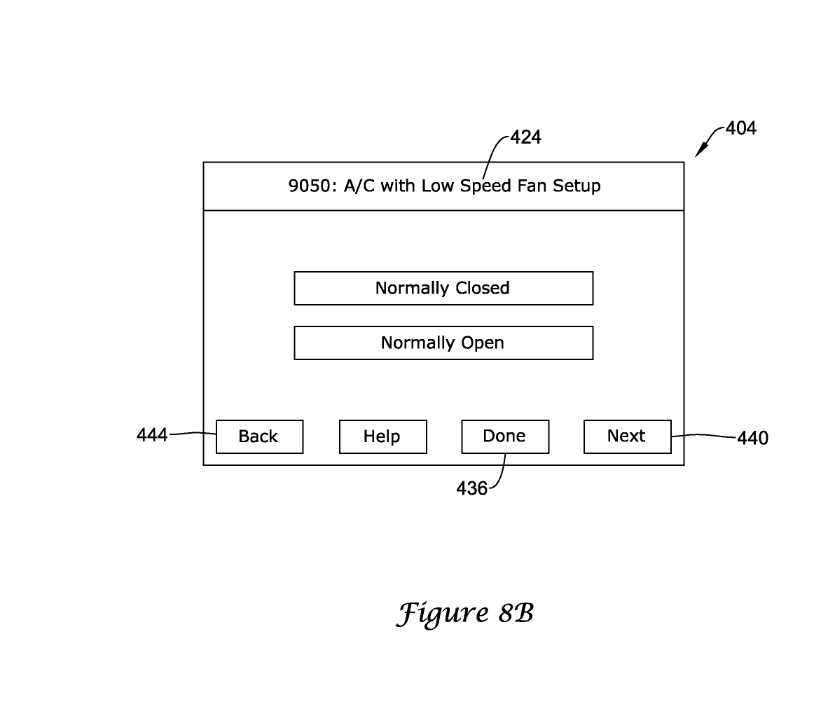

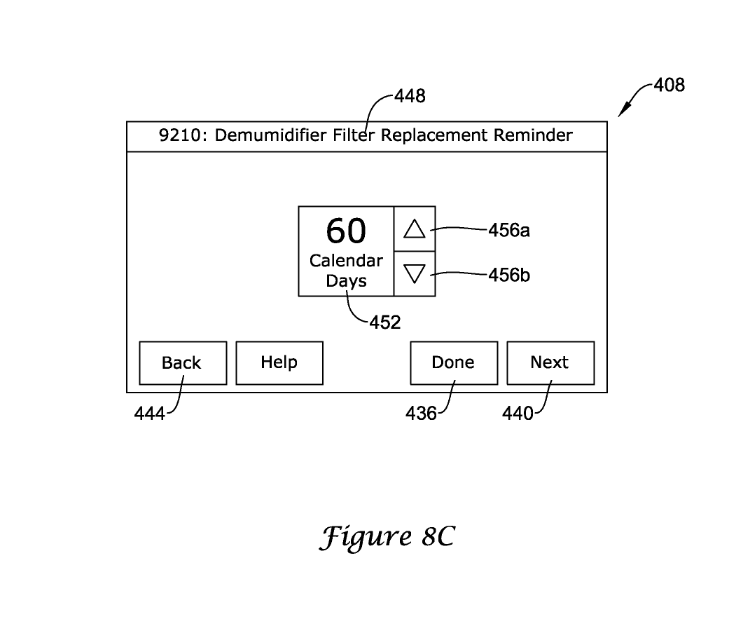

Screens 400, 404, and 408 shown in FIGS. 8A-8C may be representative of configuration parameter data packages relating to dehumidification equipment that may be included in the HVAC system 4. As shown in FIG. 8A, screen 400 may be representative of a configuration parameter data package associated with selecting the type of dehumidification equipment. Screen 400 may include a configuration parameter identifier 412 and one or more parameter values 416a-416c (e.g. none, A/C with low speed fan, A/C with high speed fan, etc.) available for selection by a user. The one or more parameter values 416a-416c may be displayed in a table 420, but this is not required. In one example, upon selection of the parameter value 416b corresponding to A/C with low speed fan by a user, the remote device 62 may transmit the selected parameter value 416b to the HVAC controller 18. In response, the HVAC controller 18 may store the dehumidification equipment type selected by the user in the memory 72 of the HVAC controller 18, and may transmit a second configuration parameter data package to the remote device 62. In some cases, the configuration parameters included in the second configuration data package transmitted by the HVAC controller 18 may be selected based, at least in part, on the user's previous selection, but this is not required.

Screen 404 shown in FIG. 8B is representative of an additional configuration data package transmitted by the HVAC controller 18 to the remote device 62 in response to the user having selected the parameter value 416b shown in FIG. 8A. Screen 404 includes a configuration parameter identifier 424 and at least a first individually selectable option 428a corresponding to a “Normally Closed” fan setup option and a second individually selectable option 428b corresponding to a “Normally Open” fan setup option. In some cases, upon selection of a fan setup option 428a or 428b, the user may either select the DONE button 436 or the NEXT button 240. Selection of either the DONE button 436 or the NEXT button 440 may cause the remote device 62 to transmit the selected fan setup option to the HVAC controller 18 where the HVAC controller 18 may store the selected fan setup option in the memory 72. Selection of the DONE button 436 may cause the remote device 62 to exit the configuration set up process, while selection of the NEXT button 440, if provided, may cause the remote device 62 to continue with configuring the HVAC controller 18. A BACK button 444 may be provided which may permit a user to return to a previous screen to verify or modify their previous selection.

Screen 408 shown in FIG. 8C is representative of yet another configuration data package relating to a reminder for replacing dehumidification filters used in the HVAC system 4 that may be transmitted by the HVAC controller 18 to the remote device 62. Screen 408 includes a configuration parameter identifier 448 and a box 452 displaying a number of day, and first and second arrows 456a, 456b for selecting the number of days that may pass before a reminder to replace the dehumidification filter is provided by the HVAC controller 18. In some cases, upon selection of the number of days that may pass before a reminder is provided, the user may either select the DONE button 436 or the NEXT button 440. Selection of either the DONE button 436 or the NEXT button 440 may cause the remote device 62 to transmit the selected number of days to the HVAC controller 18 where the HVAC controller 18 may store the selected number of days in the memory 72. Selection of the DONE button 436 may cause the remote device 62 to exit the configuration set up process, while selection of the NEXT button 440, if provided, may cause the remote device 62 to continue with configuring the HVAC controller 18. A BACK button 444 may be provided which may permit a user to return to a previous screen to verify or modify their previous selection.

The screens provided in the illustrative examples of FIGS. 5A-8C are merely exemplary. It will be generally understood that additional screens representative of additional configuration data packages relating to the configuration and/or setup of the HVAC system 4 may be transmitted by the HVAC controller 18 and received and displayed by the remote device 62, as desired.

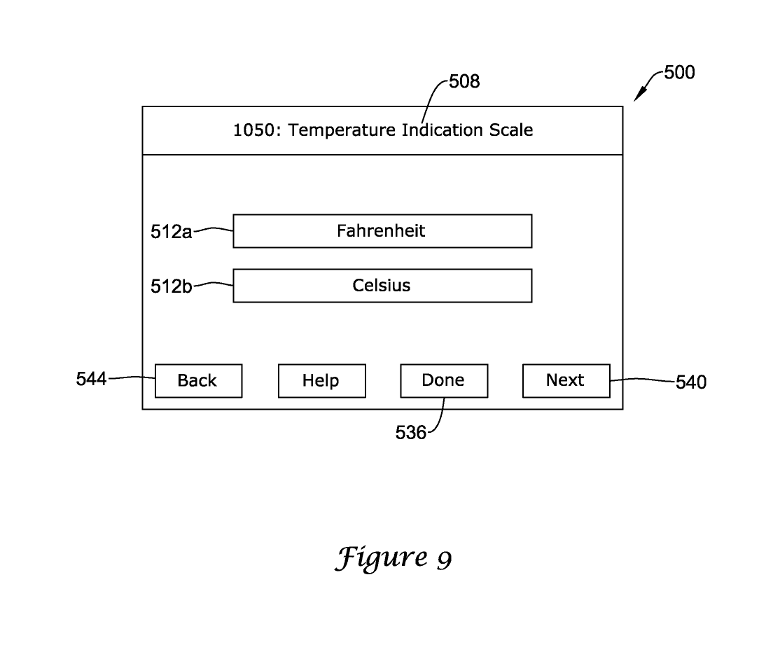

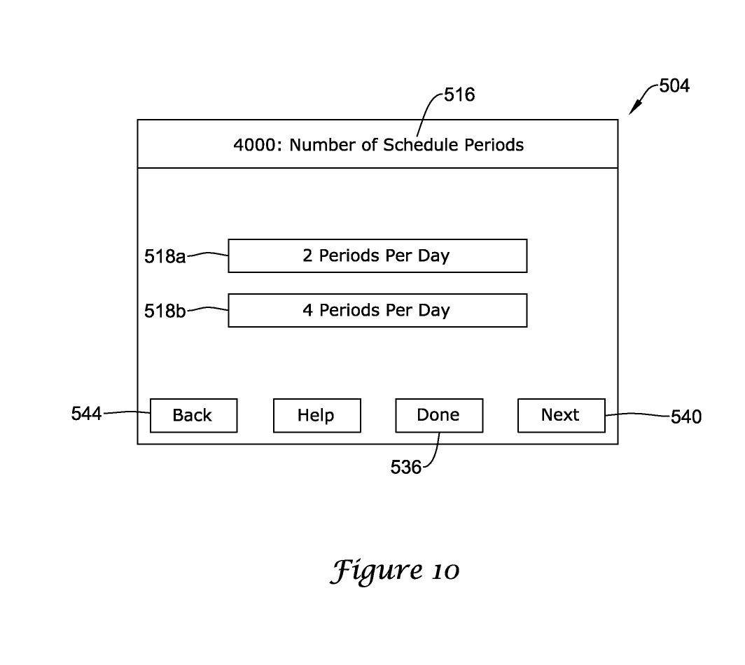

FIGS. 9 and 10 provide illustrative examples of screens that may be representative of configuration parameter data packages that relate to a user's display and/or programming preferences. The configuration parameter data packages related to a user's preferences may be transmitted by the HVAC controller 18 to the remote device 62 as a part of the configuration process. Screen 500 of FIG. 9 is representative of a configuration parameter data package that relates to a temperature indication scale that may be selected by a user. Screen 500 includes a configuration parameter identifier 508 and a first selectable option 512a corresponding to a Fahrenheit temperature indication scale, and a second selectable option 512b corresponding to a Celsius temperature indication scale. Screen 504 of FIG. 10 is representative of a configuration parameter data package that relates to a number of schedulable time periods within a day or twenty-four hour time period that may be selected by a user. Screen 504 includes a configuration parameter identifier 516 and a first selectable option 518a corresponding to two time periods per day, and a second selectable option 518b corresponding to four time periods per day. These are just some examples. It will be generally understood that additional screens representative of additional configuration data packages relating to a user's display and/or programming preferences may be transmitted by the HVAC controller 18 and received and displayed by the remote device 62.

In some cases, the controller of an HVAC controller 18 may publish a first configuration parameter data package in a computer readable form, wherein the first configuration parameter data package includes many or all of the configuration parameters for the HVAC controller 18, and information regarding the available parameter values for each of the configuration parameters. That is, the HVAC controller 18 may deliver many or all of the configuration parameters for the HVAC controller 18 and information regarding the available parameter values for each of the configuration parameters during a single transmission. When so provided, this first configuration package may be received by the remote device 62, whereupon the remote device 62 may endeavor to display the various screens and solicit the various parameter values as dictated by the first configuration parameter data package. Once the user has made the selections set forth in the first configuration parameter data package, the remote device 62 may communicate the user selections to the HVAC controller 18, sometimes during a single transmission.

In some cases, the HVAC controller 18 may deliver an application program as a payload to the remote device, wherein the application program may itself include many or all of the configuration parameters for the particular HVAC controller 18, and information regarding available parameter values for each of the configuration parameters. When so provided, the remote device 62, which is often more of a general purpose device, may be readily adapted to setup and/or configure the particular HVAC controller 18, which may have different configuration parameters and settings than another HVAC controller (e.g. an HVAC controller with a different model number).

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respect, only illustrative. Changes may be made in details, particularly in matters of shape, size, and arrangement of parts without exceeding the scope of the disclosure. The disclosure's scope is, of course, defined in the language in which the appended claims are expressed.

What is claimed is:

1. A building controller for controlling one or more HVAC components of an HVAC system of a building, the building controller comprising:
an input/output port; and
a controller in communication with the input/output port, the controller configured to publish in a computer readable form a first configuration parameter data package, wherein the first configuration parameter data package includes a first configuration parameter identifier for a first configuration parameter of the building controller and information regarding available parameter values for the first configuration parameter, the controller further configured to transmit the published first configuration parameter data package via the input/output port of the building controller.

2. The building controller of claim 1, wherein after the controller transmits the published first configuration parameter data package via the input/output port of the building controller, the controller is configured to receive a selection of a first parameter value from the available parameter values for the first configuration parameter via the input/output port, and sets the parameter value of the first configuration parameter to the selected first parameter value for use by a control algorithm that is executed during subsequent operation of the building controller.

3. The building controller of claim 2, wherein after the controller receives the selection of the first parameter value from the available parameter values for the first configuration parameter via the input/output port, the controller is configured to publish a second configuration parameter data package, wherein the second configuration parameter data package includes a second configuration parameter identifier for a second configuration parameter of the building controller and information regarding available parameter values for the second configuration parameter, the controller further configured to transmit the published second configuration parameter data package via the input/output port of the building controller.

4. The building controller of claim 3, wherein the controller selects a particular one of a plurality of configuration parameters of the building controller to publish as part of the second configuration parameter data package, the selection depending at least in part on the received first parameter value.

5. The building controller of claim 3, wherein the information regarding available parameter values for the second configuration parameter is dependent at least in part on the received first parameter value.

6. The building controller of claim 3, wherein the controller selects a particular one of a plurality of configuration parameters of the building controller to publish as part of the second configuration parameter data package, the selection depending on one or more rules stored in a memory of the building controller.

7. The building controller of claim 6, wherein the information regarding available parameter values for the second configuration parameter is dependent at least in part on one or more rules stored in a memory of the building controller.

8. The building controller of claim 1, wherein the first configuration parameter data package further includes a current parameter value of the first configuration parameter.

9. The building controller of claim 1, wherein the information regarding available parameter values for the first configuration parameter includes a valid range of parameter values.

10. The building controller of claim 1, wherein the information regarding available parameter values for the first configuration parameter includes a valid range of parameter values and valid steps for change within the valid range.

11. The building controller of claim 1, wherein the information regarding available parameter values for the first configuration parameter includes two or more discrete options.

12. The building controller of claim 1, wherein the first configuration parameter data package further includes a text string for natural language programming.

13. The building controller of claim 1, wherein the first configuration parameter data package further includes a second configuration parameter identifier for a second configuration parameter of the building controller and information regarding available parameter values for the second configuration parameter.

14. The building controller of claim 13, wherein the first configuration parameter data package further includes one or more rules relating to an interdependency between the first configuration parameter and the second configuration parameter.

15. The building controller of claim 13, wherein the first configuration parameter data package further includes one or more rules relating to an interdependency between the available parameter values for the first configuration parameter and the available parameter values for the second configuration parameter.

16. The building controller of claim 13, wherein the first configuration parameter data package further includes one or more rules relating to an interdependency between the available parameter values for the first configuration parameter and the second configuration parameter.

17. A building controller for controlling one or more HVAC components of an HVAC system of a building, the building controller comprising:
an input/output port; and
a controller in communication with the input/output port, the controller configured to publish in a computer readable form a configuration parameter data package, wherein the configuration parameter data package includes a listing of available configuration parameters for the building controller, as well as information regarding available parameter values for each of the configuration parameters.

18. The building controller of claim 17, wherein the configuration parameter data package further includes one or more rules relating to interdependencies between two or more of the available configuration parameters and/or between the available parameter values for two or more of the available configuration parameters.

19. A computer readable medium having stored thereon in a non-transitory state a program code for use by a remote wireless device connectable to a wireless network, the program code causing the remote wireless device to execute a method for configuring a building controller, the method comprising:
without first specifically requesting data for a first configuration parameter relating to a configuration setting for the building controller, receiving a first set of data relating to the first configuration parameter over the wireless network;
soliciting input from a user of the remote wireless device to select a value for the first configuration parameter;
transmitting the selected value for the first configuration parameter over the wireless network;
without first specifically requesting data for a second configuration parameter relating to another configuration setting for the building controller, receiving a second set of data relating to the second configuration parameter over the wireless network, wherein the second set of data relating to the second configuration parameter is dependent upon the selected value for the first configuration parameter;
soliciting input from the user to select a value for the second configuration parameter; and
transmitting the selected value for the second configuration parameter over the wireless network.

20. A computer readable medium having stored thereon in a non-transitory state a program code for use by a remote wireless device connectable to a wireless network, the program code causing the remote wireless device to execute a method for configuring a building controller, the method comprising:
receiving a configuration parameter data package over the wireless network, wherein the configuration parameter data package includes a listing of available configuration parameters for the building controller, as well as information regarding available parameter values for each of the configuration parameters;
soliciting input from a user of the remote wireless device to select a parameter value for at least two of the available configuration parameters; and
transmitting the selected parameter values for the at least two of the available configuration parameters over the wireless network.

21. The computer readable medium of claim 20, wherein the configuration parameter data package further includes one or more rules relating to interdependencies between two or more of the available configuration parameters and/or between the available parameter values for two or more of the available configuration parameters.

22. The computer readable medium of claim 21, wherein the wireless device is a mobile phone, tablet computer, laptop computer, or personal computer configured for wireless communication over one or more wireless networks.

23. The computer readable medium of claim 21, wherein the program code is stored on an external server for download to the remote wireless device.
